(19) United States
(12) Patent Application Publication
(10) Pub. No.: US 2025/0120422 A1
(43) Pub. Date: Apr. 17, 2025

(54) PLANT ONLY SEAFOOD FLAVORING REPLACEMENT SYSTEM

(71) Applicant: The Live Green Group, Inc., Middletown, DE (US)

(72) Inventors: Sasikanth Chemalamudi, San Fernando (CL); Priyanka Srinivas, San Fernando (CL)

(21) Appl. No.: 18/852,665

(22) PCT Filed: Jun. 29, 2023
(86) PCT No.: PCT/IB2023/056757

§ 371 Date: Sep. 30, 2024

Related U.S. Application Data
(60) Provisional application No. 63/357,042, filed on Jun. 30, 2022.

(30) Foreign Application Priority Data
Jun. 30, 2022 (US) 63/357042

(51) Int. Cl. A23L 17/60; A23L 5/10; A23L 11/00; A23L 27/10; A23L 29/212

(52) U.S. Cl. CPC A23L 17/60; A23L 5/10; A23L 11/05; A23L 27/10; A23L 29/212

(57) ABSTRACT

The aspect of the present invention is relates to a plant-only seafood flavoring replacement system. More particularly, the said replacement system comprises one or more plant-only ingredient. In an embodiment the said ingredients are selected from the group consisting of Plant-only starch source (s), Algae source (s), Ginger, Unripened legume source(s), and Aquatic plant source(s), In addition the said replacement system is improving the taste of various seafood dishes, such as sauces, dressings, seasonings, seafood salads, snacks, and appetizers, by adding delicious and savory flavors.

### PRIORITY PARAGRAPH

This application claims to the of U.S. Provisional Patent Application No. 63/357,042, filed on: Jun. 30, 2022 and PCT Patent Application No. PCT/IB2023/056757, filed on Jun. 29, 2023, and titled “PLANT ONLY SEAFOOD FLAVORING REPLACEMENT SYSTEM” and is incorporated herein by reference.

### TECHNICAL FIELD

The disclosed embodiments relate generally to food compositions and, more particularly, plant-only replacement for seafood flavoring and other chemical, synthetic and/or highly processed additives in commercially available food products such as fish burgers, fish sauces, fish meat analogues, fish alternative products, frozen fish products, seafood analogues, and other food product including food product mixes in which seafood flavor is used. Such plant-only replacements are minimally processed and are free of synthetic food additives.

### BACKGROUND

Many commercially available, processed plant-based, and animal-based (including seafood) food products contain natural and synthetic food additives such as artificial flavors and other highly processed ingredients. The commercially available food products containing such additives vary greatly and include animal flesh-based (i.e., any one or more of beef, pork, poultry, fish, shellfish and other seafood, etc.) or imitation meat/seafood-containing products (meat or seafood analogs) such as, for example, sauces, chowders, soups, bisques, instant noodles, snacks, surimi seafood, based in whole or in part on plant-derived materials, or food products comprised of a combination both animal-source and plant-sourced materials. As an example, these food products may be, in one form, commercially available fish or other seafood burgers, such as imitation crab (which contains fish and possibly other seafood sourced ingredients), etc., as well as plant-based or “plant-only” seafood alternatives (analogues). Additives, such as artificial flavors are found in all types of commercially available food products including seafood and imitation seafood (analogue) food products.

Together, all of the seafood-based and/or plant-based seafood alternative food products available commercially in any form will be referred to as “Traditional Seafood Products,” despite their origin or form. These are distinguished from the “plant-only” seafood analogue (or imitation seafood) food products, or other food products featuring a seafood flavoring. These terms are discussed in more detail and the categories distinguished further below.

Commercially available, Traditional Seafood Products are generally highly processed foods. Traditional, seafood-based products contain fish flesh or other seafood of some kind, added saturated fats, highly processed ingredients, synthetic additives and other ingredients that may be inappropriate for certain diets, e.g., vegetarian, vegan, salt-restricted, low-fat, low saturated fat, culturally- or religiously-restricted diets, etc. Even some commercially available “plant-based,” “plant-derived,” food products (depending on how those terms are defined by the manufacturers, or under definitions supported by a governmental authority in the location of manufacture) may contain animal-derived ingredients such as fish bones, fish scales as flour, and artificial flavoring agents based on processed fish or other seafood. Such animal-derived additions can render even these seafood analogue, “plant-based” products inappropriate for vegetarians and vegans.

Some seafood flavoring agents have been developed to mimic the qualities that some consumers of fish products or plant-based alternatives desire in a fish/seafood product without altering its texture, behavior at different temperatures and stability over time. Examples of food additives commonly found in Traditional Seafood Products and the seafood flavorings used in other food products are modified starches, sorbitol, glutamate and polyphosphates. Many such additives (particularly synthetic additives) could be harmful to consumers if consumed over prolonged periods. The food industry uses more than 7,000 synthetic and ultra-processed additives even though nature offers more than ten million compounds from more than 450,000 plants.

It would be desirable to provide solely plant- or fungi-derived, or other natural source-derived ingredients that are not from the animal kingdom (hereafter, “plant-only,” as further defined below) ingredients that replace highly processed, synthetic, artificial and/or animal-derived (i.e., sourced directly or indirectly from an animal) seafood flavors found in Traditional Seafood Products and fish or other seafood substitutes in any form such as fish nuggets, fish burgers, seafood analogues, etc. A “plant-only” food product is free from dairy and other animal-derived ingredients and is minimally processed, with—or, as a component of another food product, contributing to—a desirable flavor, taste, texture, homogeneity, consistency, color and appearance so as to be aesthetically pleasing to consumers.

### SUMMARY OF THE INVENTION

Aspects of the disclosure are provided herein for a plant-only seafood flavoring replacement system to be used in place of commercially available, (frequently) synthetic or processed flavorings and other additives in a variety of food products, including plant-derived imitation seafood food products. Commercially available, seafood-based and/or imitation seafood-based food products—such as highly processed plant-based, plant-derived, “fishless” (fish-free), or “seafood less” (seafood-free) types of imitation animal flesh-alternatives—are one category of food products that can benefit from replacement of commercially available, traditionally used, synthetic or processed additives. The plant-only ingredients and additives in the disclosed embodiments of the seafood flavoring replacement system provide a natural tasting seafood flavor without including any animal-derived products. In the disclosed embodiments, plant-only ingredients effectively function as flavoring agents in food products, replacing the conventional, non-plant-derived, synthetic or highly processed additives and ingredients normally found in Traditional Seafood Products and other commercially available imitation seafood food products. To be clear, in the disclosed embodiments, plant-only food additive replacements (or replacement systems) are comprised of only minimally processed, naturally occurring (i.e., non-synthetic) ingredients sourced solely from plants, fungi and algae, i.e., they are not sourced from the animal kingdom.

According to an aspect of the disclosed embodiments, a plant-only seafood flavoring replacement system for use in food products provided. The plant-only replacement seafood flavoring system use in food products includes a) 1-5% by weight of a plant-derived starch source, b) 25-65% by weight of an algae source, c) 5-15% by weight of a ginger, d) 5-10% by weight of an unripened legume source, and e) 1-5% by weight of an aquatic plant source.

According to an embodiment, the plant-derived starch source is selected from cassava (tapioca starch), navy beans, cannellini beans, corn starch, potato starch, maize, wheat, sorghum, barley, oats, sago or combinations thereof.

According to another embodiment, the algae source is selected from kelp, Kombu (Saccharina japonica), nor (Porphyra spp.), Wakame (Undaria pinnatifida), Spirulina (Arthrospira platensis), Chlorella, Sea lettuce, Irish moss, Dulce or combinations thereof.

According to another embodiment, the ginger is selected from ginger root, ginger, and garlic, cloves, tomatoes, bell peppers, chili peppers, mushrooms, spinach, broccoli, carrots, onions, Asparagus, fennel, oregano, cinnamon or combinations thereof. According to another embodiment, the unripened legume source is selected from green beans, black beans, edamame, peapods, edamame, snow peas, sugar snap peas, fava beans, lima beans, chickpeas or combinations thereof.

According to another embodiment, the aquatic plant source is selected from lotus root, water chestnut, water spinach, watercress, cattail Shoots, sea beans, water bamboo, water mimosa, water lily, kangkong or combinations thereof.

According to another embodiment, the food products comprise fish burgers, fish sauces, fish meat analogues, fish alternative products, frozen fish products, and seafood analogues.

According to another aspect of the disclosed embodiments, a method of preparing a plant-only seafood flavoring replacement system for use in food products, wherein the method includes mixing a) 1-5% by weight of a plant-derived starch source, b) 25-65% by weight of an algae source, c) 5-15% by weight of a ginger, d) 5-10% by weight of an unripened legume source, and e) 1-5% by weight of an aquatic plant source at a temperature between 60 degrees Celsius and 105 degrees Celsius for about 30 seconds to one minute to form the plant-only seafood flavoring replacement system.

According to yet another embodiment, the plant-derived starch source is selected from cassava (tapioca starch), navy beans, cannellini beans corn starch, potato starch, maize, wheat, sorghum, barley, oats, sago or combinations thereof.

According to yet another embodiment, the algae source is selected from kelp, Kombu (Saccharina japonica), Nor (Porphyra spp.), Wakame (Undaria pinnatifida), Spirulina (Arthrospira platensis), Chlorella, Sea lettuce, Irish moss, Dulce or combinations thereof.

According to yet another embodiment, the ginger is selected from ginger root, garlic, cloves, tomatoes, bell peppers, chili peppers, mushrooms, spinach, broccoli, carrots, onions, Asparagus, fennel, oregano, cinnamon or combinations thereof.

According to yet another embodiment, the unripened legume source is selected from green beans, black beans, edamame, peapods, edamame, snow peas, sugar snap peas, fava beans, lima beans, chickpeas or combinations thereof.

According to yet another embodiment, the aquatic plant source is selected from lotus root, water chestnut, water spinach, watercress, cattail shoots, sea beans, water bamboo, water mimosa, water lily, kangkong or combinations thereof.

According to yet another embodiment, the food products comprise fish burgers, fish sauces, fish meat analogues, fish alternative products, frozen fish products and seafood analogues.

According to yet another embodiment, physical characterization data associated with ingredients of the plant-only seafood flavoring replacement system comprising the plant-derived starch source, the algae source, the ginger, the unripened legume source and the aquatic plant source is stored in a database, wherein a machine learning model determines a unique combination of ingredients based on the physical characterization data to prepare the plant-only seafood flavoring replacement system.

According to yet another embodiment, the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the disclosed embodiments are described below with reference to examples for illustration. However, one skilled in the relevant art will recognize that the disclosed embodiments can be practiced without one or more of the specific details or with other methods, components, materials, and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the present invention will be described with reference to the accompanying drawings briefly described below.

FIG. 1 illustrates a flow chart of a method of preparing a plant-only replacement system for seafood in food products according to the aspect of the present disclosed embodiments.

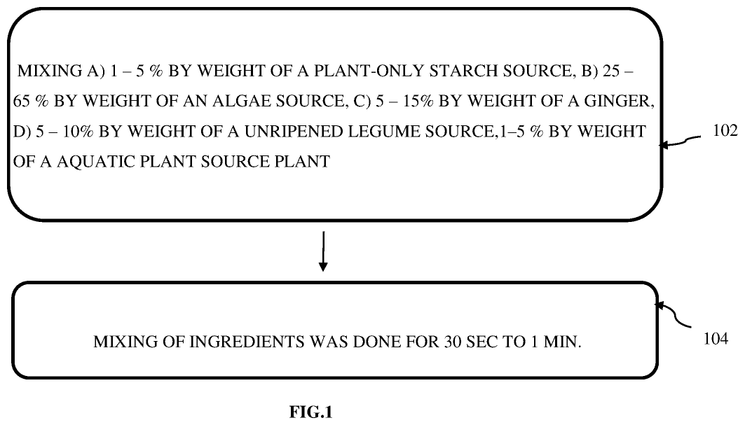

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprise one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the present invention are described with reference to the accompanying FIGURES.

In the drawings, like reference numbers generally indicate identical, functionally similar, and/or structurally similar elements. The drawing in which an element first appears is indicated by the leftmost digit(s) in the corresponding reference number.

### Definitions

The term “Seafood flavoring” refers to a Seafood flavor is a flavoring substance produced from shellfish, finfish, and shrimp. The sources can include cod, Pollock, and lobster as well. It can be produced by using different methods that include aqueous extraction, fermentation, and enzymatic hydrolysis.

The term “Proteins” refers to large biomolecules and macromolecules that comprise one or more long chains of amino acid residues.

The term “Binding agent” refers to a substance that makes a loose mixture stick together.

The term “Fiber” refers to the portion of plant-derived food that cannot be completely broken down by human digestive enzymes.

The term “Starch” refers to a polymeric carbohydrate consisting of numerous glucose units.

The term “Bulking” refers to increasing the volume or weight of a product without affecting the overall taste and aroma of the product.

The term “Texturizing” refers to improving the overall consistency, texture by enhancing features like creaminess, viscosity, mouth feel and taste.

The term “Fat” refers to a type of lipid consisting of tri-esters of glycerol and fatty acids or triglycerides.

The term “FDA” refers to Food and Drug Administration.

“Emulsifier” refers to an agent used to help mix two substances that typically separate when they are combined.

The term “Thickener” refers to a substance that increases the viscosity of a liquid without substantially changing its other properties.

The term “Stabilizer” refers to an additive to food that helps to preserve its structure.

The term “Flavoring agent” refers to an additive that provides an additional taste or flavor.

The term “Homogeneous mixture” refers to a mixture that has the same proportions of its components throughout a given sample.

The term “Blender” refers to an appliance used to mix, crush, puree or emulsify food and other substances.

The term “Machine learning model” refers to computer software designed to recognize patterns or behaviors based on previous experience or data.

The term “Plant-based” refers to largely or solely of vegetables, grains, pulses, or other foods derived from plants, rather than animal products.

The term “Plant-derived” refers to ingredients extracted from a plant.

The term “Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

A plant-only food product or formulation that is free from dairy and other animal-based ingredients is described herein that has desirable flavor, taste, texture, homogeneity, consistency, color and appearance so as to be aesthetically pleasing prior to consumption. The terms “plant-derived is used,” in this disclosure to refer to any ingredient, or component of a food product that is derived or extracted or obtained from plants with minimal processing. The term plant-only is used in this disclosure to refer to a system, composition, formulation or the entire food product itself, that is produced, developed or otherwise obtained directly or indirectly from one or more of the plant-derived ingredients, component that is obtained from plants with minimal processing. Although a plant-only, food product may consist of materials that are 100 percent sourced from one or more plants, the term also encompasses food products that may contain components or ingredients that are not obtained from plants. For example, while some of the water content of a food product may be derived from a plant source, water may also be added to the product from an external source. For example, in scenarios in which a plant-only system or plant-only food product is in the form of a gel or liquid, it is further understood that water can be included as a solvent or liquid carrier for the plant-only system or plant-only food product, where any amount of water (some or all) within the system or food product may or may not be derived from a plant source. In some embodiments, apart from added water, the plant-only food product consists entirely (100%) of components or ingredients from a plant genus (i.e., photosynthetic eukaryotes from the kingdom Plantae), and further excluding any component or ingredient that is dairy-based, that is from the animal genus (including animal fats and animal proteins) and also excludes any synthetically derived component or ingredient. The plant-derived ingredients of the food product described herein replace conventional animal-based ingredients, including milk, cream and eggs, as well as conventional additives such as gums, stabilizers, emulsifiers, preservatives, anti-freezing and anti-caking agents, binders, etc. The product formed solely from plant-derived ingredients is further free from gluten, soy, cholesterol and Trans fatty acids.

The selection of specific plant-derived ingredients, or specific combinations (i.e., systems) of plant-derived ingredients provide effective functionalities such as emulsifiers, stabilizers, texturizing and thickening, fat replacement, sugars or other sweeteners, anti-freezing properties, anti-caking properties, etc., for the food product without the need to add such conventional, non-plant-derived additives. As used herein, the terms “agent,” “component,” or “ingredient” are used interchangeably and refer to a particular item that includes one or more chemical compounds (e.g., a food item from the plant species that comprises one or more naturally occurring chemical compounds). The term “plant-derived”, as used herein, refers to a product or formulation (e.g., food product or food formulation).

Embodiments disclosed herein include the plant-only seafood replacement system, or components of it, for replacing various ingredients or combinations of ingredients traditionally found in commercially available food products, including seafood-based products or seafood analogue (i.e., imitation seafood) food products. In some embodiments the seafood flavoring replacement system or individual ingredients in the system replace flavorings and other additives found in Traditional Seafood Products, as well as the artificial seafood flavors and enhance the nutritional or aesthetic value of the food product. In other embodiments the seafood flavoring replacement system's plant only ingredients may replace any—even partially—animal-derived ingredients of so-called “plant derived,” plant-based,” or other seafood-free food product, including such food product mixes.

The seafood flavor replacement system is not intended to be consumed as a stand-alone product, but rather, may become a consumable food product when mixed with other ingredients and possibly other plant-only replacement systems disclosed elsewhere. The consumable food products may be plant-only food products, plant-based food products, or even animal flesh-based food products.

“Plant-only” products disclosed herein, as opposed to products labeled as “plant-derived,” “plant based,” “fishless,” “fish-free” “seafood less”, “seafood-free” and the like, refer to food products whose ingredients, apart from any significant amount of water added, are derived solely from sources outside of the animal kingdom, e.g., from plants, fungi, or algae. That is, “plant-only” may refer to any agent, ingredient, or component of a food product, or the entire food product itself, that is produced, developed, or otherwise obtained directly or indirectly from one or more plants, fungi, or algae, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from outside the plant or fungi kingdoms, or in any event not sourced from the animal kingdom. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contains no animal-sourced content), and seeks to certify—through its own certification process—food products, including food product mixes, that meet this standard See (https://www.plantbasedfoods.org/policy/labeling/). The terminology used on a label for a plant-based food must be truthful under FDA regulations; however, in the US, no regulatory body currently requires a company to refrain from including some amount of meat, animal flesh or other animal-sourced ingredients in a “plant-based” product.

In certain embodiments, while some of the water content of a food product may be derived from a plant source, water may also be added to the product from an external source. For example, in scenarios in which a plant only agent or system or plant only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only fish and seafood replacement system (or any other plant-only replacement system referenced herein). In other embodiments the plant only flavoring replacement system may be available in a dried form; in certain embodiments the dried form may be powdered; in other embodiments, the dried form of the flavoring replacement system may be in a partially powdered form; in other embodiments it may be available in a semi-liquid or gel form; in other embodiments it may be in a liquid or frozen form.

In the disclosed embodiments, apart from externally-sourced water, the plant-derived food product consists entirely of ingredients derived from plants, fungi or algae, excluding any component or ingredient that is: (i) dairy-based or otherwise derived from any member of the animal kingdom; and (ii) more than minimally processed; and (ii) synthetic. In some embodiments, the plant-only seafood flavoring replacement system, or components thereof, replace conventional ingredients and additives found in seafood-based food products such as commercially available seafood-based “nuggets.” In other embodiments the seafood flavoring replacement system replaces those additives found in commercially available plant-based, plant-derived, seafood-free, animal-free food products of all forms, that range from imitation seafood burgers and burger mixes other seafood or imitation seafood products to sauces and frozen food products.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, e.g., a food item from a member of the plant or fungi kingdoms that comprises one or more naturally occurring chemical compounds.

Together, all of the meat-based and/or plant-based meat alternative food products available commercially in any form will be referred to as “Traditional Burger Products.” These are distinguished from the plant-only burgers and burger mixes, collectively, plant-only “burger products,” as well as the plant-only methylcellulose replacement system of the disclosed embodiments. These terms are discussed in more detail and the categories are distinguished further below.

### Functionality and Parameters

TABLE 1
Parameter ranges associated with ingredients of the plant-only
replacement system for seafood flavoring in food products

| Categories | Parameters and Ranges | | | |
|---|---|---|---|---|
| 1. Plant-only starch source(s): | Primary | Content | Free | Flavor |
| | bioactive | of startch: | glutamic | Aromatics: |
| | compounds | 40-89% | acid | Meaty, |
| | responsible | Wheat: | content: | savory, |
| | for seafood | 40% | 10-106 | umami |
| | flavor | Rice: 89% | mg/100 g | |
| | Disodium | Wheat: | Potato: 10 | |
| | inosinate | 74% | Corn: 106 | |
| | (formed by | Sorghum: | | |
| | the | 74% | | |
| | fermentation | | | |
| | of sugar), | | | |
| | glutamic | | | |
| | acid | | | |
| | Note: Startch | | | |
| | is the precursor | | | |
| | molecule | | | |
| 2. Algae source(s) | Primary | Free | Iodine/ | Flavor |
| | compounds | glutamate | iodide | Aromatics: |
| | responsible | mg (100 g)- | content | Umami, |
| | for seafood | 1 dw | (in mg/kg): | Salty, |
| | flavor | 8-600 or | 16-2523.5 | Earthy, |
| | salt and iodide, | more. | mg/kg | Savory, |
| | glutamate, the | | Nori: | Mineral |
| | precursor to | | 29.3-45.8 | like taste |
| | monosodium | | Kelp: | due to |
| | glutamate | | 8,000 | iodine, |
| | | | Winged | Mild and |
| | | | kelp: | Sweet, |
| | | | 190-990 | Briny, |
| | | | Kombu: | Fresh and |
| | | | 1,200-3,000 | Grassy. |
| | | | Sugar kelp: | |
| | | | 300-12,000 | |
| | | | Wakame: | |
| | | | 93.9-185.1 | |
| | | | Important to | |
| | | | note: The | |
| | | | utilization | |
| | | | of seaweeds | |
| | | | is taken | |
| | | | considering | |
| | | | the | |
| | | | recommended | |
| | | | dietary | |
| | | | reference | |
| | | | intake of 0.15 | |
| | | | mg/d and 0.14 | |
| | | | mg/d for iodine | |
| | | | and tolerable | |
| | | | upper intake | |
| | | | level (UL) for | |
| | | | iodine. | |
| 3. Ginger | Primary | Range of | Range of | Flavor |
| | bioactive | Glutamic | phenolic | Aromatics |
| | compounds | acid | compound | Woody, |
| | responsible | concentration: | concentration: | floral |
| | for seafood | 4.13-11.12 | 4.4-315.3 mg | notes, citrus, |
| | flavor | (g/100 g) | GAE g⁻¹ | spicy, |
| | Glutamic acid, | Ginger: 4.13 | | pungent, |
| | phenolic | Garlic: 9.33 | | |
| | compounds | Onion: 6.87 | | |
| 4. Unripened legume | Primary | Range of | Fatty Acid | Flavor |
| source(s) | bioactive | Glutamic | Content in | Aromatics |
| | compounds | acid in | legumes: | Cooked |
| | responsible | legume | Ranges from | fish flavor, |
| | for seafood | sources: | 47.3% to 71% | Beanie, |
| | flavor | 1.3 to 42 | Black bean- | earthy |
| | dimethyl | g/100 g of | 70.95 | |
| | trisulfide and | protein | Fava Bean- | |
| | furans (mainly | Green beans- | 56.29 | |
| | 2-pentilfurans), | 1.85 | Chickpea- | |
| | formed from | Black Beans- | 48.8 | |
| | amino acids | 1.35 | | |
| | through the | Edamame- | | |
| | amadori | 3.13 | | |
| | rearrangement | | | |
| | and fatty acid | | | |
| | oxidation | | | |
| 5. Aquatic plant source(s) | Primary | Range of | Glutamic Acid | Flavor |
| | bioactive | Volatile | conc.: | Aromatics: |
| | compounds | components: | 6.46 mg/g- | similar to |
| | responsible | 3-90% or | dependning | monosodium |
| | for seafood | more | upon the extent | glutamate, |
| | flavor | Lotus root: | of processsing | slightly |
| | Glutamic acid | Volatile | like frying. | earthy taste |
| | phenolic | compounds- | Water spinach- | and bitter bite |
| | compounds | 38 | 11.91 g/100 g | |
| | volatile | Volatile | of Protein | |
| | aldehydes | Aldehydes- | Watercress- | |
| | (nonanal, | 14.02% | 65 mg | |
| | decanal) | Watercress-4 | | |
| | | Volatile | | |
| | | compounds- | | |
| | | 96.5% | | |
| | | Water | | |
| | | spinach- | | |
| | | 3.87% | | |

The selection of a specific combination of ingredients for plant-only products was determined using a proprietary machine learning (ML) platform, which blends ancestral wisdoms of plant nutrition with biotechnology and ML to analyze members of, primarily, the plant and fungi kingdoms, as well as other potential, natural, sources outside of the animal kingdom for the compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.) and aesthetic properties relating to flavorings. Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-only ingredients was determined to yield an effective flavoring replacement formulation that can be used to forming a desirable food product or formulation that is effective as a substitute for conventional ingredients in seafood products and seafood analogues or for providing flavoring sensory features in seafood food products.

As noted, the proprietary system identifies natural alternatives, i.e., plant-only alternatives to synthetic, artificial, and animal-derived products, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). The information recommended by the proprietary Charaka system permits one to choose among hundreds of alternatives based on ingredients intended to alter a variety of properties to give optimal results for aesthetic purposes (i.e., flavorings, mouth feel, etc.) as well as physiological functionality, health, and environmental sustainability.

A food product flavoring replacement system as described herein functions to replace additives and flavorings in seafood products or seafood analogue products and comprises a combination of plant- or fungi-, or algae-sourced ingredients and added water, if any is required for their preparation. The plant-only ingredients and combinations of ingredients selected for the flavoring replacement system are consistent with the requirements and specifications of achieving the Attorney Reference: 4237.0018P 8 sensory features exhibited by convention flavoring agents, when used in food products containing seafood or seafood analogues.

### EXAMPLE EMBODIMENTS

The disclosed embodiments are illustrated in further detail by the following non-limiting examples.

TABLE 2
Percent by weight of each of the preferred, essential, Seafood
Flavoring replacement categories of ingredients in the plant-only
replacement system for Seafood Flavoring in food products.

| | Preferred |
|---|---|
| | Weight |
| | Percent of |
| Preferred, Essential Plant-Only Seafood | the |
| Flavoring Replacement System | Replacement |
| Categories/Ingredients | System |
| 1. Plant-only starch source(s): any one or more of cassava | 1-5 |
| (tapioca starch), navy beans, cannellini beans, and/or any | |
| substitutes imparting the same or similar flavorings | |
| 2. Algae source(s): any one or more of kelp, dulse, | 25-65 |
| wakame and/or any substitutes imparting the | |
| same or similar flavorings | |
| 3. Ginger (ginger root) and/or any substitute | 5-15 |
| imparting the same or similar flavorings | |
| 4. Unripened legume source(s): any one or more | 5-10 |
| of green beans, black beans, edamame, | |
| peapods, and/or any substitutes | |
| imparting the same or similar flavorings | |
| 5. Aquatic plant source(s): any one or more of lotus | 1-5 |
| root, water chestnut, and/or any substitutes | |
| imparting the same or similar flavorings | |

In some embodiments, within each of the five categories in Table 1, one of the listed ingredients (or one or more plant-only alternatives to that ingredient, which alternatives impart the same or similar flavor as the replaced ingredient) may be used as the seafood flavoring replacement system. In other embodiments, two or more listed ingredients (or their plant-only alternatives, as above) may be combined in varying amounts for the replacement system. In certain embodiments one or more representative ingredients from each of the five categories are mixed to form the replacement system. In still other alternative embodiments, any of the ingredients listed in Table 1 may be replaced by one or more plant-only substitute ingredients (not listed) that impart the same or similar flavors to the food product.

Although Table 1 provides a preferred, essential list of categories of ingredients imparting particular a variety of flavorings in the seafood flavoring replacement system, substitutions for these ingredients in the replacement system may be made in alternative embodiments for compliance with dietary requirements, without limitation, such as food sensitivities and food allergies.

The seafood flavoring replacement system detailed in Table 1 as a component of another food product (such as in Traditional Seafood Products) comprises generally between about 0.5 to about 5 to 10 percent dry weight of the total weight of the food product, but may vary between as much as 20 percent or more of the total weight, depending on the moisture content of the flavoring replacement system and that of the food product in which it is incorporated.

The seafood flavoring replacement system may comprise, as a percent by weight of the food product to which it is added, and depending on the type of food product and whether water or other liquid is included as part of the food product, between about 0.5 to about 20 percent or more, between about 0.5 and about 2 percent, between about 0.5 and 4 percent, between about 0.6 to about 0.8 percent, between about 0.8 to about 1 percent, between about 1 to about 1.2 percent, between about 1.2 to about 1.4 percent, between about 1.4 to about 1.6 percent, between about 1.6 to about 1.8 percent, between about 1.8 to about 2.0 percent, between about 2.0 to about 2.5 percent, between about 2 to about 3 percent, between about 3 to about 5 percent, between about 5 to about 7 percent, between about 6 to about 8 percent, between about 7 to about 10 percent, between about 8 to about 12 percent, between about 10 to about 15 percent, and between about 15 to about 20 percent of the total weight of the food product in which the replacement system is incorporated.

### Categories of Ingredients Among the Preferred, Essential Categories of Ingredients in the Seafood Replacement System

In other embodiments, one or more plant-only, minimally processed and non-synthetic alternative ingredients imparting the same or similar flavors may also be used in place of one or more (or all of) the listed ingredients to impart the same or similar flavorings as those replaced Table 2 ingredients.

Category 1—plant-only starch source(s): Tapioca starch is produced from cassava, a root vegetable of the cassava shrub. The cassava root is washed and pulp is made; a starchy liquid is extracted from the wet pulp and dried to produce tapioca starch. Tapioca starch has an amylopectin/amylose ratio of 80:15 and introduces a pulpy, gelatin-like texture to food products through its ability to develop high levels of cross-linking. Tapioca starch contains 5′-inosinate, and the combination of both glutamate and 5′ nucleotides such as 5′inosinate, particularly, increasing the ratio of 5′-inosinate (or 5′-guanylate) to glutamate, produces a synergistic effect that significantly enhances the umami taste over that produced by glutamate alone. The strong umami taste is due to the proximity of binding sites for both glutamate and the 5′ nucleotides on the T1R1 and T1R3 taste receptors, the receptors that permit humans to experience the umami taste. The binding of glutamate alone leads to some stabilization, and the binding of, e.g., 5′-inosinate, further stabilizes the “active” conformation of the molecule. (Kurihara. Umami the fifth basic taste: history of studies on receptor mechanisms and role as a food flavor. BioMed Res Int'l. (2015) http://dx.doi.org/10.1155/2015/189402). Tapioca starch promotes the Ayurvedic properties of Rasa (Madura—sweet), Lavana (salty), Guna (Sheeta), Virya (Hima/Sheeta—cold) and Vipaka (Madhura—sweet) as shown in Table 3.

Alternative plant-only starch sources include canellini beans and other common beans, each of which, in this seafood flavoring replacement system designed by the machine learning system, may be interchanged with the others or may be used in combination of two or more of these ingredients, or with (or substituted by) other ingredients known to a person of ordinary skill that would provide the same or similar flavorings and perhaps characteristics and features (functionality and properties) for this category in the system. Further detail on this category is found in Table 2. In some embodiments, tapioca starch or their equivalents (e.g., Lima or cannellini beans) as a source of starch are provided in the seafood flavoring replacement system as a finely ground powder. In other embodiments they may be mixed with water, plant-derived liquid or other non-animal-sourced liquid to form a liquid, gel or other alternative form of the system suitable for mixing, storing, freezing and/or drying.

In the disclosed embodiments the dry weight amount of plant-only starches (one or more of tapioca, navy beans, cannellini beans, common beans and/or one or more substitutes that have the same or similar composition, and possibly also the same or similar properties and functionalities as these ingredients) as a percentage of the seafood flavoring replacement system weight ranges between about 0.5 to about 10 percent, between about 0.5 to about 1 percent, between about 0.7 to about 2 percent, between about 0.8 to about 3 percent, between about 1 to about 4 percent, between about 1 to about 5 percent, between about 2 to about 4 percent, between about 3 and about 6 percent, between about 4 to about 7 percent, between about 5 to about 8 percent, between about 6 to about 8 percent, between about 7 to about 9 percent, and between about 8 to about 10 percent of the total weight of the seafood flavoring replacement system.

Category 2—algae source(s): Algae are an extremely diverse, predominantly aquatic, photosynthetic organisms. Algae, unlike bacteria, are eukaryotes and, like plants, have the green pigment, chlorophyll and carry out photosynthesis. They have rigid cell walls, but unlike plants, algae lack roots, stems, leaves, and specialized multicellular reproductive structures. Kelp is one example of a species of algae whose salt and iodide content serves as a natural seafood flavoring in food products. In certain embodiments, alternative algae such as dulse, a form of red alga (seaweed) found along the northern Atlantic and Pacific oceans, and wakame, a brown alga (seaweed or sea vegetable) that grows on the sea floor between China and Japan. Both types are high in vitamins and minerals and may be used, and can contribute to the plant-only seafood flavoring of the disclosed replacement system for a variety of food products. Each of these may be interchanged with one or more of the others or two or more may be used in combination or may be substituted by other ingredients known to a person of ordinary skill that would provide the same flavorings, and possibly similar characteristics and features (properties, functionalities) as other ingredients in this category of the system. Further detail on this category is found in Table 2.

Kelp is rich in iodide and is part of the “forest under the sea.” Kelp contains glutamate, the precursor to monosodium glutamate, a chemical ingredient found in traditional seafood flavorings and other additive systems. In some embodiments, kelp or other alga ingredient in this category is provided in the seafood flavoring replacement system as a finely ground powder. In other embodiments they may be mixed with water, plant-derived liquid or other non-animal-sourced liquid to form a liquid, gel or other alternative form of the system suitable for mixing, storing, freezing and/or drying. In other embodiments, it is provided in liquid or gel form. Kelp promotes the ayurvedic properties of Rasa: Lavana (Salty), Guna: Laghu (Light), Virya: Sheeta (cold) and Vipaka: Lavana (salty).

In the disclosed embodiments the (dry weight) amount of algae source(s) (one or more of kelp, wakame, dulse or other species of algae and/or one or more substitutes that have the same or similar flavors, and possibly also the same or similar properties and functionalities as these ingredients as a percent of the seafood flavoring replacement system weight, ranges from between about 15 to about 75 percent, between about 15 to about 20 percent, between about 18 to about 23 percent, between about 20 to about 28 percent, between about 23 to about 30 percent, between about 25 and about 65 percent, between about 26 to about 35 percent, between about 30 to about 40 percent, between about 35 and about 45 percent, between about 40 to about 50 percent, between about 45 to about 55 percent, between about 48 to about 68 percent, between about 50 to about 70 percent, between about 55 to about 72 percent, and between about 57 to about 75 percent.

Category 3—ginger root: (Zingiber officinale) is the sole named ingredient in this category in preferred embodiments. In alternative embodiments ginger root may be replaced by one or more plant-only ingredients that impart the same or similar flavors, and possibly other characteristics and features as does ginger root. It is an important source of vitamins and minerals, is used as a spice. Ginger contains gingerols, the pungent features of phenolic compounds that are responsible for its pharmacological activity. Ginger root also contains glutamic acid, which contributes to a “fishy” flavor as well as umami flavor. In some embodiments ginger root is provided in the seafood flavoring replacement system as a finely ground powder. In other embodiments it may be mixed with water, plant-derived liquid or other non-animal-sourced liquid to form a liquid, gel or other alternative form of the system suitable for mixing, storing, freezing and/or drying. Ginger root promotes the ayurvedic properties of Rasa: Katu (Pungent), Vipaka: Madhura (Sweet), Virya: Heat, Guna, and Laghu (Light).

In the disclosed embodiments the (dry weight) amount of ginger root and/or one or more substitutes that have the same or similar flavors, and possibly also the same or similar properties and functionalities as ginger root as a percent of the seafood flavoring replacement system weight, ranges from between about 1 to about 20 percent, between about 1 to about 5 percent, between about 5 to about 10 percent, between about 5 to about 15 percent, between about 10 to about 15 percent, and between about 15 to about 20 percent.

Category 4: unripened legume source(s): Green beans, the unripe fruits of common beans, are one example of a legume whose molecular composition imparts a natural seafood flavoring: dimethyl trisulfide and furans (mainly 2-pentilfurans), formed from amino acids through the amadori rearrangement and fatty acid oxidation, play a crucial role in the flavor profile of cooked fish. As a result, unripened legumes can be used as part of the seafood flavoring replacement system in food products. Alternative sources include black beans, edamame, and pea pods, each of which may be interchanged with the others or may be used in combination of two or more of these ingredients, or with (or substituted by) other ingredients known to a person of ordinary skill that would provide the same flavorings, and possibly similar characteristics and features for this category in the system. Further detail on this category is found in Table 2. In some embodiments, unripened legumes are provided in the seafood flavoring replacement system as a finely ground powder. In other embodiments the legume powder or other form may be mixed with water, plant-derived liquid or other non-animal-sourced liquid to form a liquid, gel or other alternative form of the system suitable for mixing, storing, freezing and/or drying. Green beans promote the ayurvedic properties of Rasa: Kashaya (astringent) and Guna: Laghu (easy to digest).

In the disclosed embodiments the amount of legumes (dry weight) and/or one or more substitutes that have the same or similar flavors, and possibly also the same or similar properties and functionalities as these ingredients as a percent of the seafood flavoring replacement system weight, ranges from between about 1 to about 15 percent, between about 1 to about 5 percent, between about 5 to about 10 percent, between about 10 to about 15 percent, and between about 15 to about 20 percent.

Category 5—Aquatic plant source(s) Aquatic plants are those that have adapted to living in or around marine or fresh water, marshes, beaches, among mangroves, etc. The lotus is one example of an aquatic plant whose root (“lotus root”) is a rhizome—the bulb of the flower of the same name—is naturally low in fat, and is a good source of carbohydrates, fiber, vitamins and mineral to the seafood flavor replacement system in food products. Alternatives to lotus root include water chestnuts and Salicornia herbaceae (also known as sea asparagus or sea beans, samphire or crow's foot), each of which may be interchanged with the others or may be used in combination of two or more of these ingredients, or with (or substituted by) other ingredients known to a person of ordinary skill that would provide the same flavorings, and possibly similar characteristics and features for this category in the system. Further detail on this category is found in Table 2.

Lotus root contains glutamic acid, an organic acid used for umami flavor. Lotus root is high in antioxidants and is rich in phenolic compounds and volatile aldehydes (nonanal, decanal) that contribute to the seafood aroma profile. In some embodiments, lotus root and other aquatic plant components may be provided in the seafood flavoring replacement system as a finely ground powder. In other embodiments the lotus root powder or other form may be mixed with water, plant-derived liquid or other non-animal-sourced liquid to form a liquid, gel or other alternative form of the system suitable for mixing, storing, freezing and/or drying. Lotus root promotes the ayurvedic properties of Rasa: Kashaya (astringent), Madhura (sweet), Titka (bitter), Virya: Sheeta (cold), Guna: Laghu (lightness), Snigdha (oily), Picchila (Sticky), and Vipaka: Madhura (sweet).

The single ingredient or combinations of plant-only starches (potentiate umami flavor), algae sources (saltiness, high iodine content), ginger root (umami and seafood flavor), plant-only unripened fruits (seafood aroma and taste), and plant-only aquatic plants (umami and seafood flavor) along with their Ayurvedic properties, results in a plant only seafood flavoring replacement system that may be used in whole or part in any variety of food products. Alone or in combination as a seafood flavoring replacement system, the previously described ingredient categories are effective and natural flavoring agents in the seafood flavoring replacement system in an amount of about 0.5 percent to up to 10 percent or more by weight of the food product, depending on the type of food product.

In the disclosed embodiments the dry weight amount of ingredient(s) sourced from aquatic plants and/or one or more substitutes that have the same or similar flavors, and possibly also the same or similar properties and functionalities as these ingredients as a percent of the seafood flavoring replacement system weight, ranges from between about 0.5 to about 10 percent, between about 0.5 to about 1 percent, between about 0.7 to about 2 percent, between about 0.8 to about 3 percent, between about 1 to about 4 percent, between about 1 to about 5 percent, between about 2 to about 4 percent, between about 3 and about 6 percent, between about 4 to about 7 percent, between about 5 to about 8 percent, between about 6 to about 8 percent, between about 7 to about 9 percent, and between about 8 to about 10 percent.

TABLE 3
Plant-only seafood flavoring replacement system
categories of ingredients, and their properties and
their properties and functionalities

| | | Compounds | | |
|---|---|---|---|---|
| | Functionality | responsible | Physico- | |
| | as a | for the | chemical | Ayurvedic |
| Ingredient | flavoring | functionality | properties | properties |
| Category 1: | Tapioca | 5′inosinate | pH: | Rasa |
| plant-only | starch | | 4.7-5.3 | (Madura- |
| starch | contains | | Moisture | sweet), |
| source(s): | 5′inosinate, | | content: | Lavana |
| cassava | and the | | 10-13.5% | (salty), |
| (tapioca | combination | | | guna |
| starch) | of both | | | (Sheeta), |
| | glutamate | | | Virya |
| | and 5′inosinate, | | | (Hima/ |
| | produces a | | | Sheeta- |
| | synergistic | | | cold) and |
| | effect that | | | Vipaka |
| | significantly | | | (Madhura- |
| | strengthens | | | sweet) |
| | the umami | | | |
| | taste | | | |
| Category 2: | Members of | Umami | Moisture: | Rasa: |
| algae | the brown | flavor due to | 83.3 + 1.15%. | Lavana |
| sources, | or red algae | high | pH: high as | (salty), |
| such as kelp, | families, | glutamate | 8.38 during | Guna: |
| dulse, wakame | providing | content. | the day, and | Laghu |
| and/or other | umami and | | as low as | (light), |
| substitutes | seafood flavors. | | 7.69 at night. | Virya: |
| with the same | | | Density: | Sheeta |
| or seafood | | | 338.14 g/L | (cold); |
| flavorings, | | | | and |
| properties | | | | Vipaka: |
| and/or | | | | Lavana |
| functionalities | | | | (salty) |
| Category 3: | Ginger imparts | Glutamic | Moisture | Rasa: Katu |
| Ginger root | umami flavors | acid is the | content: | (pungent) |
| (Zingiberaceae) | with its | predominant | 83%-94% | Vipaka: |
| and/or | characteristic | compound | on a wet basis | Madhura |
| substitutes | spiciness | responsible | pH: | (sweet) |
| providing the | and refreshing | for the umami | 5.60-5.90 | Virya: |
| same or | aroma | effective | Density: | Heat; and |
| similar seafood | | stimuli. | 435.6-410.78 | Guana: |
| flavorings, | | Aspartic | g/l | Laghu |
| properties | | acid, | | (light) |
| and/or | | glutamic | | |
| functionalities | | acid, glycine, | | |
| | | alanine, and | | |
| | | proline | | |
| | | strongly | | |
| | | affected the | | |
| | | umami taste. | | |
| Category 4: | Green beans | The odor- | Moisture | Rasa: |
| unripened | contian volatile | active | content: 90%, | Kashaya |
| legume sources | compounds that | compound, | at harvest; | (astringent); |
| such as green | contribute to | dimethyl | 14%, dried | and Guna: |
| beans, black | the flavor. | trisulfide, is | pH: 6.0 to | Laghu |
| beans, edamame, | Odor-active | known to | 6.3 | (easy to |
| or peapods, | compounds | give a “fishy” | Density: | digest) |
| and/or substitutes | contribute to | and rotten | 1.01 g/cm3 | |
| with the same or | the “fishy” | odor. Furanes | | |
| similar seafood | odor. | present in | | |
| flavorings, | | green beans | | |
| properties and/or | | contributes | | |
| functionalities | | to a “cooked | | |
| | | fish” aroma | | |
| Category 5: | Lotus roots | Glutamic | Glutamic | Rasa: |
| aquatic plants: | contain glutamic | acid and | acid content: | Kashaya |
| Lotus (providing | acid, responsible | starch | 100 mg/100 g | (astringent), |
| lotus root), with | for umami | compounds | Moisture | Madhura |
| an umami | flavor. | are responsible | content: | (sweet), |
| flavor, water | | for the umami | 72.14% | Titka |
| chestnuts, | | flavor and | pH: 5 | (bitter), |
| and/or substitutes | | mouthfeel. | | Virya: |
| with the same or | | Aldehydes | | Sheeta |
| similar flavorings, | | imparta | | (cold), |
| properties and/or | | “cooked | | Guna: Laghu |
| functionalities | | fish” aroma | | (lightness), |
| | | | | Snigdha |
| | | | | (oily), |
| | | | | Picchila |
| | | | | (Sticky), and |
| | | | | Vipaka: |
| | | | | Madhura |
| | | | | (sweet) |

### Preparation of the Seafood Flavoring Replacement System or its Component Categories

At step 102, a) 1-5% by weight of a plant-only starch source, b) 25-65% by weight of an algae source, c) 5-15% by weight of a ginger, d) 5-10% by weight of a unripened legume source, 1-5% by weight of an aquatic plant source plant. 104, mixing of ingredient was done for 30 see to one minuet.

In one embodiment, the seafood flavor replacement system, or any of its individual categories, individual ingredients or combinations of ingredients within each category, can be prepared by combining and mixing the dried, powdered ingredients selected from Table 1 in the relative amounts identified as preferred, essential ingredients of the system to be used in a desired food product. In some embodiments the seafood flavoring replacement system may be in the form of a liquid or gel due to the addition of water or other plant-derived liquid. In some embodiments the seafood flavoring replacement system is mixed with additional water or plant-derived liquid, then dried and powdered and stored. In some embodiments the seafood flavoring replacement system is prepared in liquid form and freeze dried. In certain embodiments, the seafood flavoring replacement system may be prepared and stored as a liquid or moist form. In certain other embodiments the seafood flavoring replacement system may be prepared as a liquid, gel or in dried form and then frozen for storage. In other embodiments, each of the categories of ingredients, individual ingredients, or combinations of ingredients within each of the categories of the seafood flavoring replacement system, whether in liquid, gel, dried or other form, are mixed individually directly into and become a part of another food product rather than being combined as the complete replacement system prior to incorporation into another food product. The addition of a liquid to the replacement system will necessarily modify (increase) relative weight of the replacement system as a component of a food product.

In some embodiments the seafood flavoring replacement system stands alone as a plant-only food product that can be added to one or more ingredients or other food replacement systems to form any type of consumable food product requiring a seafood flavoring. In other embodiments the seafood flavoring replacement system is a component of another food product, such as a Traditional Seafood Product, or as an imitation seafood analogue. In certain embodiments the seafood flavoring replacement system is a component of a baked good food product, a soup or sauce, or a frozen food product mix (such as a burger, patties or other shape, or mix), which may then be incorporated into other food products.

In still other embodiments the food product is one of several components used to create the final food product. In some embodiments the food product is a Traditional Seafood Product. In other embodiments, the ingredients listed in Table 3 may be selected and combined in other relative amounts (a variety of ranges) identified for each of the categories to achieve the required functional and aesthetic features most closely resembling those of conventionally used, commercially available flavorings and additives. In other embodiments, the seafood flavoring replacement system may be used as an alternative, natural option to enhance the flavor of pet and other animal feeds.

The combination of categories and ingredients comprising a seafood flavoring replacement system for traditional ingredients and additives in commercially available animal- and plant-based products, as well as their physicochemical and Ayurvedic properties are shown in Table 3.

TABLE 4
Typical ingredients in a commercially available seafood
flavoring mix that would be replaced by the plant-only
seafood flavoring replacement system

| Typical Flavoring | Percent Weight of |
|---|---|
| Mix Ingredients | Flavoring Mix |
| Monosodium Glutamate (MSG) | 5-15 |
| Garlic puree | 5-10 |
| Red wine vinegar | 3-5 |
| Mushroom paste | 5-15 |
| Tomato paste or puree | 10-30 |
| Black olives | 5-10 |
| Beef or chicken stock, | 5-15 |
| and/or anchovy paste | |

Table 4 provides an example of a typical ingredients in a commercially available seafood flavoring mix. The seafood flavoring replacement system of the disclosed embodiments can be used in whole or in part to replace the mix detailed in Table 4.

### Methods and Preparation of Plant Only Seafood Flavoring Replacement System in Food Products:

In an embodiment the seafood flavoring replacement system, or any of its individual categories and blends of ingredients, can be prepared by combining and mixing the dried, powdered ingredients selected from Table 2 in the relative amounts identified as preferred, essential ingredients of the system to be used in a desired food product.

In one embodiment the seafood flavoring replacement system, comprises Plant-only starch source: Tapioca: Cleaning, washing, peeling, and chopping cassava roots, feeding them to a saw-tooth rasper for intense attrition into a pulpy slurry, removing proteins and fibers through extractors and centrifugation, filtering the starch slurry using a coarse extractor with a finer screen (140-200 mesh), recovering the filtered starch from the final starch stream, and drying it.

In an another embodiment seafood flavoring replacement system, comprises Algae source: Kelp: Washing kelp with distilled water, chopping it into small pieces, liquidizing it using an electronic blender, filtering the liquidized kelp with a 0.45 m membrane filter, heating the collected filtrate up to 60° C., spray drying the seaweed filtrate by feeding it into the main chamber through a peristaltic pump at a rate of 8 mL h-1, setting the hot air flow rate in the drying chamber at 40 m3 h-1 and the compressor air pressure at 1.2 MPa at 130, 140, and 150° C., storing the obtained seaweed powder in a plastic container, and storing it in desiccators.

In certain other embodiment seafood flavoring replacement system, comprises Ginger: Collecting fresh ginger, chopping or grating it, spreading it on a flat surface for drying, blending the dried ginger in a grinder, sieving the sample through a fine strainer, passing large pieces through the spice grinder and blending again, and storing the sample in a dry container at room temperature.

In an another embodiment seafood flavoring replacement system, comprises Unripened legume source: Green Beans: Washing and blanching green beans, draining excess water and spreading the beans on a dehydrator tray or baking sheet, drying them at around 120° F. or 50° C. until completely dry and brittle, grinding the dried beans into a fine powder using a spice grinder or blender, and sifting the powder through a fine mesh sieve to remove any larger particles, then storing the green bean powder in an airtight container.

In some embodiments, seafood flavoring replacement system, comprises Aquatic plant source: Lotus Root: Peeling the outer skin and slicing the lotus root into thin pieces, blanching the slices in boiling water for a brief period (typically 3-4 minutes) to preserve their texture, draining the blanched slices and immediately transferring them to an ice bath to cool down, drying the cooled slices evenly on a dehydrator tray or baking sheet at a low temperature (around 120° F. or 50° C.) until completely dry and crispy, grinding the dried lotus root slices into a fine powder using a spice grinder or blender, and passing the powder through a fine mesh sieve to remove any coarse particles.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the FIGURES and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying FIGURES.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only seafood flavoring replacement system for use in food products comprising:
a) 1-5% by weight of a plant-derived starch source, b) 25-65% by weight of an algae source, c) 5-15% by weight of a ginger, d) 5-10% by weight of an unripened legume source, and e) 1-5% by weight of an aquatic plant source.

2. The plant-only seafood flavoring replacement system as claimed in claim 1, wherein the plant-derived starch source is selected from cassava (tapioca starch), navy beans, cannellini beans, corn starch, potato starch, maize, wheat, sorghum, barley, oats, sago or combinations thereof.

3. The plant-only seafood flavoring replacement system as claimed in claim 1, wherein the algae source is selected from kelp, Kombu (Saccharina japonica), Nor (Porphyra spp.), Wakame (Undaria pinnatifida), Spirulina (Arthrospira platensis), Chlorella, Sea lettuce, Irish moss, Dulce or combinations thereof.

4. The plant-only seafood flavoring replacement system as claimed in claim 1, wherein the ginger is selected from ginger root, ginger, garlic, cloves, tomatoes, bell peppers, chili peppers, mushrooms, spinach, broccoli, carrots, onions, Asparagus, fennel, oregano, cinnamon or combinations thereof.

5. The plant-only seafood flavoring replacement system as claimed in claim 1, wherein the unripened legume source is selected from green beans, black beans, edamame, peapods, edamame, snow peas, sugar snap peas, fava beans, lima beans, chickpeas or combinations thereof.

6. The plant-only seafood flavoring replacement system as claimed in claim 1, wherein the aquatic plant source is selected from lotus root, water chestnut, water spinach, watercress, cattail Shoots, sea beans, water bamboo, water mimosa, water lily, kangkong or combinations thereof.

7. The plant-only seafood flavoring replacement system as claimed in claim 1, wherein the food products comprises fish burgers, fish sauces, fish meat analogues, fish alternative products, frozen fish products, and seafood analogues.

8. A method of preparing a plant-only seafood flavoring replacement system for use in food products, wherein the method comprises:
mixing a) 1-5% by weight of a plant-derived starch source, b) 25-65% by weight of an algae source, c) 5-15% by weight of a ginger, d) 5-10% by weight of an unripened legume source, and e) 1-5% by weight of an aquatic plant source at a temperature between 60 degrees Celsius and 105 degrees Celsius for about 30 seconds to one minute to form the plant-only seafood flavoring replacement system.

9. The method as claimed in claim 8, wherein the plant-derived starch source is selected from cassava (tapioca starch), navy beans, cannellini beans corn starch, potato starch, maize, wheat, sorghum, barley, oats, sago or combinations thereof.

10. The method as claimed in claim 8, wherein the algae source is selected from kelp, Kombu (Saccharina japonica), Nor (Porphyra spp.), Wakame (Undaria pinnatifida), Spirulina (Arthrospira platensis), Chlorella, Sea lettuce, Irish moss, Dulce or combinations thereof.

11. The method as claimed in claim 8, wherein the ginger is selected from ginger root, garlic, cloves, tomatoes, bell peppers, chili peppers, mushrooms, spinach, broccoli, carrots, onions, Asparagus, fennel, oregano, cinnamon or combinations thereof.

12. The method as claimed in claim 8, wherein the unripened legume source is selected from green beans, black beans, edamame, peapods, edamame, snow peas, sugar snap peas, fava beans, lima beans, chickpeas or combinations thereof.

13. The method as claimed in claim 8, wherein the aquatic plant source is selected from lotus root, water chestnut, water spinach, watercress, cattail shoots, sea beans, water bamboo, water mimosa, water lily, kangkong or combinations thereof.

14. The method as claimed in claim 8, wherein the food products comprises fish burgers, fish sauces, fish meat analogues, fish alternative products, frozen fish products and seafood analogues.

15. The method as claimed in claim 8, wherein physical characterization data associated with ingredients of the plant-only seafood flavoring replacement system comprising the plant-derived starch source, the algae source, the ginger, the unripened legume source and the aquatic plant source is stored in a database, wherein a machine learning model determines a unique combination of ingredients based on the physical characterization data to prepare the plant-only seafood flavoring replacement system.

16. The method as claimed in claim 15, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
